(19) United States
(12) Patent Application Publication
(10) Pub. No.: US 2018/0349936 A1
(43) Pub. Date: Dec. 6, 2018

(54) PRODUCT SALES PROMOTION METHOD

(71) Applicant: Takayuki Izumi, Tokyo (JP)

(72) Inventor: Takayuki Izumi, Tokyo (JP)

(73) Assignee: Takayuki Izumi, Tokyo (JP)

(21) Appl. No.: 15/777,995

(22) PCT Filed: Jan. 7, 2016
(86) PCT No.: PCT/JP2016/050284

§ 371 Date: May 22, 2018

(30) Foreign Application Priority Data
Nov. 26, 2015 (JP) 2015-230402

(51) Int. Cl. G06Q 30/02

(52) U.S. Cl. CPC G06Q 30/0214; G06Q 30/0236

(57) ABSTRACT

It is an object to provide a product sales promotion method that is extremely advantageous for acquiring a new product purchaser. This object is achieved by the product sales promotion method in which a storage means is caused to store a point in time when a purchaser fulfilled an entry requirement and an entry term to which each purchaser belongs is determined, each purchaser is assigned a serial number larger than a serial number assigned to an existing member belonging to an immediately preceding entry term, every time bonus granting time arrives, a member who maintains a bonus granting requirement is arranged such that the higher the serial number, the higher position the member is positioned at, and a value obtained by multiplying the number of subordinate persons viewed from each member by a unit bonus amount is calculated, and a bonus is granted to each member.

### TECHNICAL FIELD

The present invention relates to a product sales promotion method in which a purchaser who fulfills a specific requirement is registered as a member and a bonus is given to the member. More specifically, the present invention is a product sales promotion method in which a new member can receive a large bonus and therefore participation of the new members is greatly promoted.

### BACKGROUND ART

There is known a sales promotion method (network business) in which in selling products such as cosmetics, health foods, ornaments, in a case where a consumer who purchased a product introduces the product to an acquaintance, a friend, or the like is given a certain reward to the consumer, and as a result, the number of purchasers are increased.

Compared with a flow of general product distribution (from a manufacturer through a wholesaler and a retailer, a product arrives at a final consumer), such a network business has advantages that advertising expenses and an intermediary distribution margin can be suppressed and good quality products can be provided to consumers.

As examples of a network business, various methods in which a purchaser becomes an introducer, introduces a product to another purchaser, and an introduction fee is paid to the introducer when the introduced person purchases the product have been proposed (for example, Patent Literatures 1 to 4).

In the methods of Patent Literatures 1 to 4, the introducer introduces the product to a plurality of persons to be introduced, as a result, a pyramid-type hierarchical structure of purchasers in which the introducer is a superior person and the introduced persons are subordinate persons is formed, and the superior is paid a reward according to the number of the subordinate persons.

However, since in such a method, a new purchaser is positioned at the bottom of the hierarchy, as the product spreads to many consumers, it becomes extremely difficult to acquire a new purchaser (introduced person) (and obtain the introduction reward).

For this reason, the purchase of the product by the consumers is not necessarily promoted, and a trouble is likely to occur between the purchaser who had excessive expectations for obtaining the introduction reward but could not obtain the introduction reward as he or she wishes and a seller.

Although the network business is a powerful method to directly provide good quality products to consumers, as mentioned above, the conventional method does not necessarily demonstrate effectiveness for expanding purchasers (promotion of product purchase). For this reason, development of a method that facilitates acquisition of new product purchasers has been desired.

### CITATION LIST

### Patent Literature

Patent Literature 1: JP 2004-318631 A
Patent Literature 2: JP 2007-011448 A
Patent Literature 3: JP 2006-293586 A
Patent Literature 4: JP 2008-090804 A

### SUMMARY OF INVENTION

### Technical Problem

The present invention has been made in view of the above background art and it is an object of the present invention to provide a product sales promotion method that is extremely advantageous in acquiring new product purchasers even in a state in which a product has widespread considerably even in the product sales promotion method in which a purchaser is given a bonus.

### Solution to Problem

The inventor of the present invention conducted intensive studies in order to solve the above problems and as a result, found that unlike the conventional methods, a consumer who purchased a product earlier is not arranged at a higher position in a pyramid-type hierarchical structure, but a consumer who purchased the product later is arranged at a higher position and as a result, the purchaser can receive a large bonus immediately after participating in the hierarchical structure and this is extremely advantageous in acquiring new product purchasers. As a result, the inventor of the present invention completed the present invention.

That is, the present invention provides a product sales promotion method in which after a serial number is assigned to a purchaser who fulfills a specific entry requirement, the purchaser is registered as a member in a pyramid-type hierarchical structure composed of purchasers, and a bonus of an amount according to the number of subordinate persons viewed from each member is periodically given to the member, and as a result, willingness to purchase a product is increased. The product sales promotion method includes at least an entry term determination step in which a storage means is caused to store a point in time when the purchaser who fulfills the entry requirement fulfilled the entry requirement and an entry term to which each purchaser belongs is determined, a numbering registration step in which every time the entry term expires, a numbering registration means assigns a serial number of the purchaser belonging to the entry term such that the serial number is larger than a serial number assigned to an existing member belonging to an immediately preceding entry term and registers the purchaser belonging to the entry term as a new member, an arrangement step in which every time bonus granting time arrives, an arrangement means arranges a member who maintains a bonus granting requirement such that the larger the serial number is, the higher position the member is arranged at and fills the hierarchy sequentially from the top, a bonus amount calculation step in which a bonus amount calculating means calculates, regarding each arranged member, a value obtained by multiplying the number of subordinate persons (limited to subordinate persons within a certain number of hierarchies (N)) viewed from the member by a unit bonus amount, and a bonus granting step in which a bonus is granted to each member.

### Advantageous Effects of Invention

According to the present invention, since the purchaser who newly participates in the hierarchical structure can receive a large bonus from the beginning, a person who knows the product is stimulated willingness to purchase the product and it becomes easy for a seller to acquire a new product purchaser.

In addition, the conventional method has a disadvantage that the method gives consumers excessive expectations for obtaining the introduction reward and as a result, troubles easily occur between consumers and sellers. A purchaser who was not particularly interested in the quality of a product or the like and purchased the product for the purpose of a reward and participated in a hierarchical structure is particularly prone to have dissatisfaction.

In this regard, in the method of the present invention, there is a possibility that immediately after the purchaser participates in the hierarchical structure (becomes a new product purchaser), the purchaser can receive a large bonus, but thereafter the bonus amount that the purchaser can receive decreases. In the method of the present invention, there is no need to stimulate consumers' gambling spirit in vain, only purchasers who are truly satisfied with the quality of a purchased product or the like after using the product remain as continuation purchasers (repeaters). As a result, advertising expenses and the like are suppressed, facilitating providing good quality products to consumers who really want the products.

### BRIEF DESCRIPTION OF DRAWINGS

FIG. 1 is a schematic diagram illustrating an example of a pyramid-type hierarchical structure. FIG. 1(a) illustrates a case of two subordinate persons for one superior person. FIG. 1(b) illustrates a case of three subordinate persons for one superior person.

FIG. 2 is a schematic diagram illustrating an example of a method of assigning a serial number in a numbering registration step.

FIG. 3 is a schematic diagram illustrating an example of a method of arranging members in an arrangement step.

FIG. 4 is a schematic diagram illustrating an example of a method of arranging members in a specific hierarchy in an arrangement step. FIG. 4(a) illustrates a case where the members are arranged alternately on the right and left sides with the members with large serial numbers on the left side. FIG. 4(b) illustrates a case where the members with large serial numbers are arranged sequentially from the left side.

FIG. 5 is a schematic diagram illustrating an exemplary range of subordinate persons who serve as the basis for calculating a bonus amount.

FIG. 6 is a flowchart illustrating a flow of processing in an entry term determination step.

FIG. 7 is a flowchart illustrating a flow of processing in a numbering registration step.

FIG. 8 is a flowchart illustrating a flow of processing in an arrangement step and a bonus amount calculation step.

FIG. 9 is an example of a screen illustrating information on a purchaser.

FIG. 10 is examples of a screen in which members belonging to a hierarchical structure are arranged in order of serial numbers.

FIG. 11 is an example of a screen illustrating a bonus amount to be granted to each member.

FIG. 12 is screens illustrating arrangement order of members in bonus granting time in a first embodiment. FIG. 12(a) is a view illustrating after expiration in October 2015. FIG. 12(b) is a view illustrating after expiration in November 2015.

### DESCRIPTION OF EMBODIMENTS

Hereinafter, the present invention will be described, but the present invention is not limited to the following embodiments and can be implemented by modifying arbitrarily.

The method of the present invention is a product sales promotion method in which a serial number is assigned to a purchaser who fulfills a specific entry requirement, and then the purchaser is registered as a member in a pyramid-type hierarchical structure composed of purchasers, a bonus of an amount according to the number of subordinate persons viewed from each member is given periodically to the member, and as a result, willingness to purchase a product is improved.

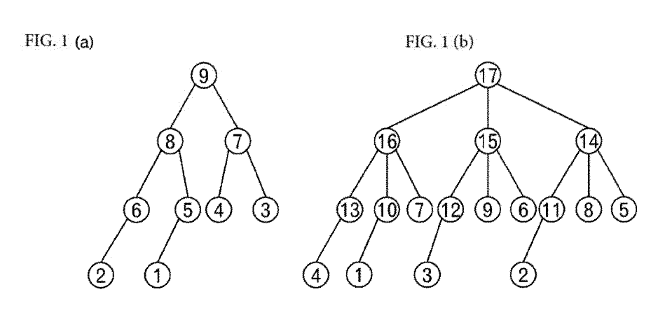

FIG. 1 is a conceptual diagram illustrating a pyramid-type hierarchical structure in the present invention. In FIG. 1, a circle with a number written therein represents a person who fulfills a specific entry requirement (requirement to enter the hierarchical structure) such as by purchasing a product and is assigned a serial number in a numbering registration step to be described later (in the present description, such a person is referred to as “member”). The number in the circle represents the serial number of the person.

In the present description, a person with serial number 1 is represented as “1” in double quotations, a person with serial number 2 as “2”, and other persons with subsequent numbers are represented similarly.

FIG. 1(a) illustrates an example of a hierarchical structure in a case where there are nine members. This example is an example in which there are two subordinate persons for one superior person.

“9” is positioned at the top of the hierarchical structure, and two persons “8” and “7” are positioned under “9”. For example, in a case where “8” is considered as a reference, “9” is a superior person in an upper hierarchy by one level, “6” and “5” are subordinate persons in a lower hierarchy by one level, “2” and “1” are subordinate persons in a lower hierarchy by two levels.

In the method of the present invention, as the serial number is larger, the member is arranged at a higher position and the hierarchy is filled sequentially from the top. In the case of FIG. 1(a), up to the third hierarchy from the top is filled, but the fourth hierarchy is not filled.

According to the present invention, every time the bonus granting time arrives, the members are periodically arranged in the hierarchical structure, and regarding each arranged member, a reward of an amount obtained by multiplying the number of subordinate persons by a unit bonus amount (X) is given.

For example, in a case where an arrangement as illustrated in FIG. 1(a) is obtained when the bonus granting time arrives, the bonus amount that “9” can receive is 8×, the bonus amount that “7” can receive is 2×, the bonus amount that “5” can receive is X, the bonus amount that “1” can receive is 0.

FIG. 1(b) illustrates an example of a hierarchical structure in a case where there are 17 members. This example is an example of a case where there are three subordinate persons for one superior person.

Regardless of the number of subordinate persons for one superior person, the subordinate persons and the superior person can be called “pyramid-type hierarchical structure” and the present invention can be implemented. Hereinafter, in the present description, a case where there are two subordinate persons for one superior person will be described as an example.

Various methods of forming such a pyramid-type hierarchical structure composed of purchasers and giving a reward (introduction reward) to a superior person in the hierarchical structure according to the number of subordinate persons have been proposed as described in Patent Literatures 1 to 4. However, in these methods, a person who purchased a product earlier is positioned at a higher position in a hierarchy and tends to receive a large reward (introduction reward).

Meanwhile, in the method of the present invention, among members who fulfills a specific entry requirement and becomes members (purchasers who have a right to enter the hierarchical structure), as a member is assigned a larger serial number, the member is positioned at a higher position and can receive a large bonus. In the present invention, since a person who becomes a member later tends to be assigned a large serial number, a person who becomes a new member can expect a large bonus, and willingness to purchase products improves.

The product sales promotion method of the present invention includes at least an entry term determination step, a numbering registration step, an arrangement step, a bonus amount calculation step, and a bonus granting step.

Each step will be described below.

### <Entry Term Determination Step>

The entry term determination step is a step in which a storage means is caused to store a point in time when the purchaser who fulfills an entry requirement fulfilled the entry requirement and an entry term to which each purchaser belongs is determined.

“Fulfilling an entry requirement” can be exemplified by that a certain number of products has been purchased, a purchase price for products has reached a certain amount of money, a product has been introduced to a certain number of others, but not limited to these examples.

For example, in a first embodiment to be described later, a setting is made such that in a case where a specific purchaser fulfills any of the following, the case is referred to as “fulfilling the entry requirement”.

(a) The purchaser himself or herself purchased three products.

(b) The purchaser himself or herself purchased two products and introduced the products to one other person.

(c) The purchaser himself or herself purchased one product and introduced the product to two other persons. This is done because it is thought that “purchasing a product by purchaser himself or herself” can be regarded to be the same as “introducing the product to one other person”.

The “entry term” is a term obtained by dividing a point in time when the purchaser fulfilled the entry requirement by a regular time interval.

As a period of the entry term, one week, half a month, one month, three months, a half year, one year, and the like are conceivable, but from a viewpoint of convenience of clerical processing and a viewpoint of maintaining interests of purchasers, it is preferable to set the entry term as one month, and it is more preferable to set the entry term as one month from the beginning of the month to the end of the month in order to clarify a system.

Of course, in a case where the entry term is set as an entry term other than the above, the case does not fall outside the scope of the present invention.

In the entry term determination step, the storage means of a computer is caused to store the point in time when the purchaser who fulfills the entry requirement fulfilled the entry requirement and the entry term to which each purchaser belongs is determined.

For example, in a case where one month from the beginning of the month to the end of the month is set as an entry term, it is possible to specify the entry term to which the purchaser belongs in the form of “month 20xx.”

The entry term determination step may be performed at any frequency. For example, the entry term determination step may be performed immediately after every time it is confirmed that a purchaser who fulfills an entry requirement appears, the entry term determination step may be performed collectively after a certain number of purchasers who fulfills the entry requirement has appeared, or the entry term determination step may be performed collectively at a specific timing (for example, in a case where one month from the beginning of the month to the end of the month is set as an entry term, on the first day of the next month) after the entry term expires.

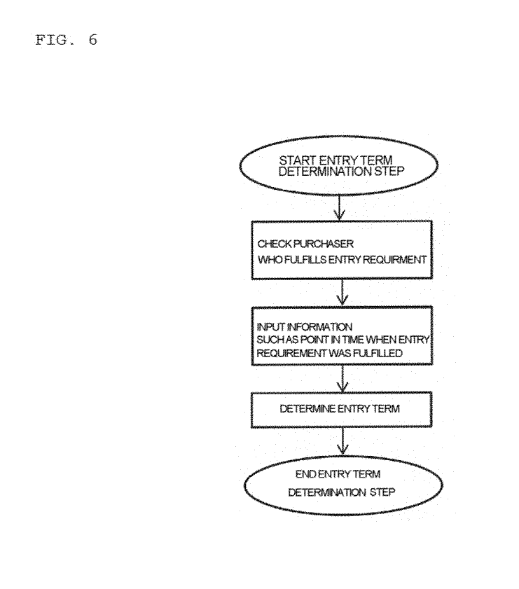

FIG. 6 illustrates a flow of processing in the entry term determination step.

After it is confirmed that a purchaser who fulfills the entry requirement appears, an operator or the like causes the storage means to store point in time when the purchaser fulfilled the entry requirement. As a result, an entry term to which the purchaser belongs is determined according to a predetermined rule.

For example, in a case where one month from the beginning of the month to the end of the month is set as an entry term, if a purchaser who fulfills the entry requirement appeared on Aug. 3, 2015, the operator or the like enters “Aug. 3, 2015” in the storage means of the computer and causes the storage means to store “Aug. 3, 2015”. As a result, the entry term of the purchaser is determined to be “August 2015.”

It is preferable that at the time of input, the operator or the like inputs not only the point in time when the purchaser fulfilled the entry requirement, but also other information on the purchaser (such as an address, a name, a phone number, a mail address, account information, and a product purchase history) at the same time.

In order, for example, to respond to an inquiry from a purchaser, it is preferable that the information on the purchaser can be browsed by the operator and the like as occasion demands and the information can be updated when the information is changed.

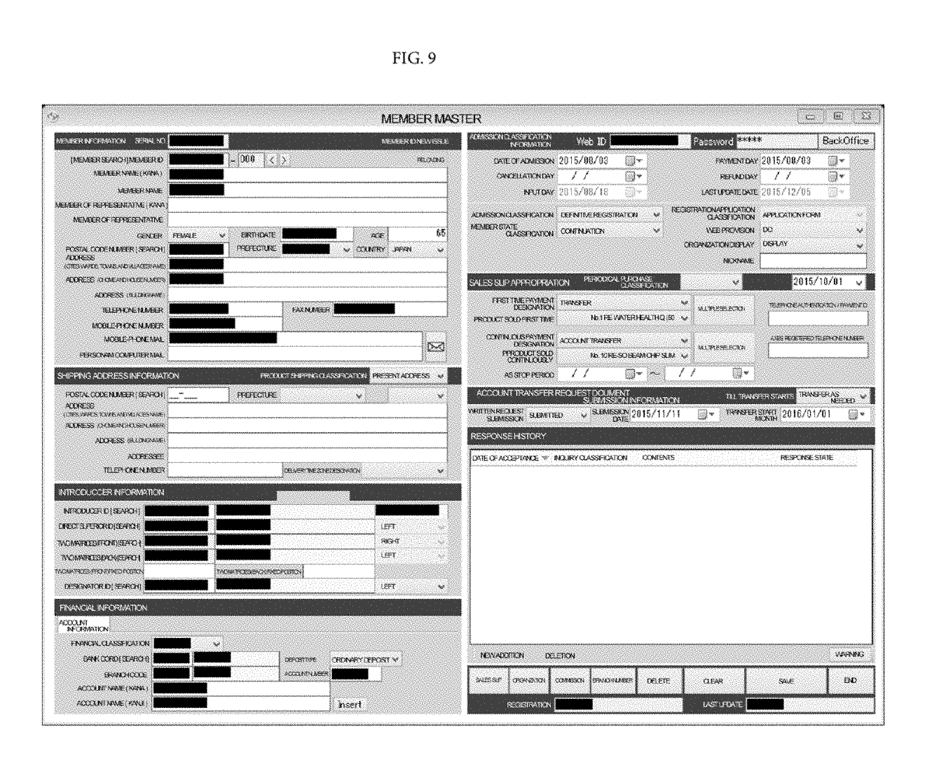

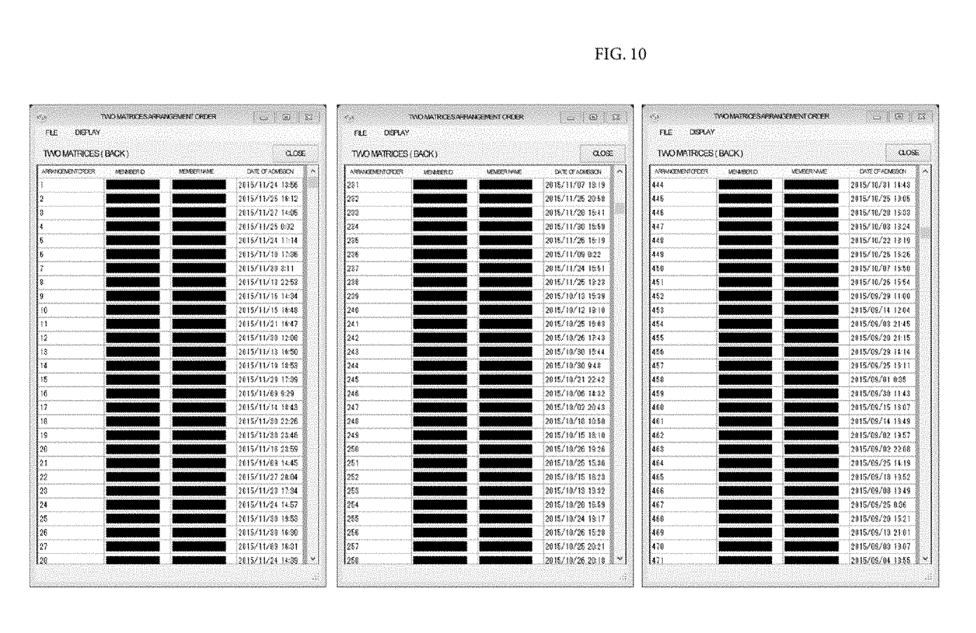

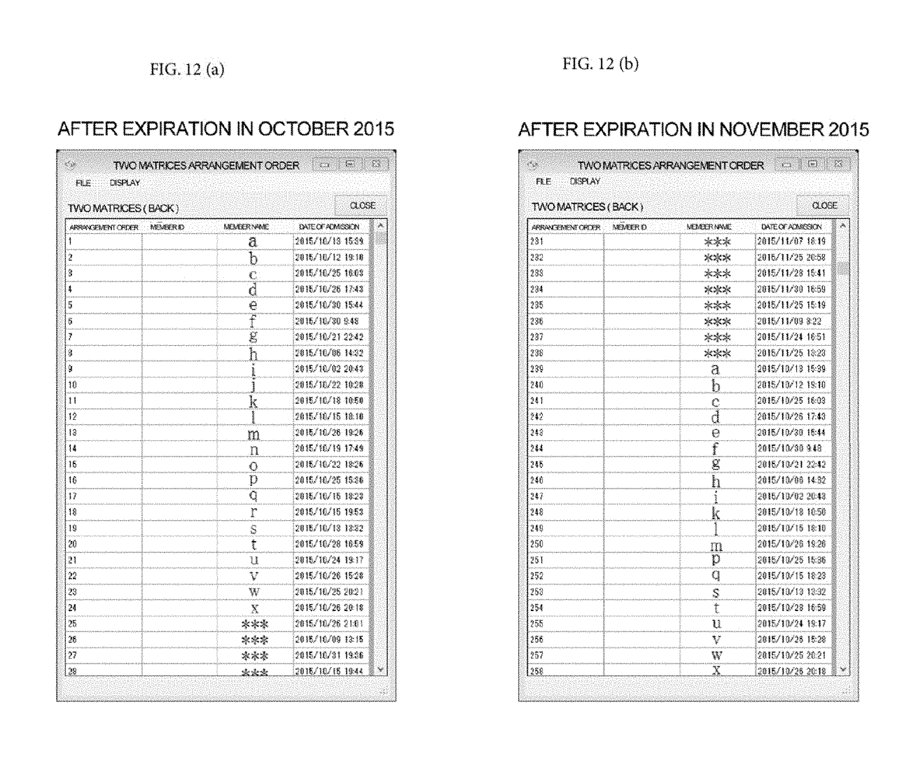

FIG. 9 is an example of a screen illustrating information on a purchaser. Regarding the purchaser (member) displayed in FIG. 9, the “date of admission” is a date of a point in time when the purchaser fulfilled the entry requirement (the same applies to FIGS. 10 and 12).

### <Numbering Registration Step>

The numbering registration step is a step in which every time the entry term expires, the numbering registration means assigns a serial number of the purchaser belonging to the entry term such that the serial number is larger than a serial number assigned to an existing member belonging to an immediately preceding entry term, and registers the purchaser belonging to the entry term as a new member.

In the numbering registration step, a serial number of each purchaser is determined and each purchaser is registered as a new member assigned the serial number. The registered member enters the hierarchical structure and has a right to receive the bonus every time the bonus granting time arrives.

The numbering registration step is performed every time the entry term expires (that is, every time a purchaser belonging to the entry term is determined).

From a viewpoint of labor saving, it is preferable to configure such that numbering registration step is performed automatically by the computer after the expiration of each entry term.

In addition, although the numbering registration step may be performed immediately after the expiration of each entry term, it is sometimes better to leave some interval from a viewpoint of convenience of clerical processing (for example, response to time lag in a case where it is decided to send a document by mail).

For example, in a case where one month from the beginning of the month to the end of the month is set as an entry term, a case where the numbering registration step is performed on the 15th day of the following month is conceivable.

In the numbering registration step performed every time the entry term expires, the serial number of the purchaser belonging to the entry term (that is, the purchaser to be registered as a new member) is assigned such that the serial number is larger than the serial number assigned to the existing member belonging to the immediately preceding entry term.

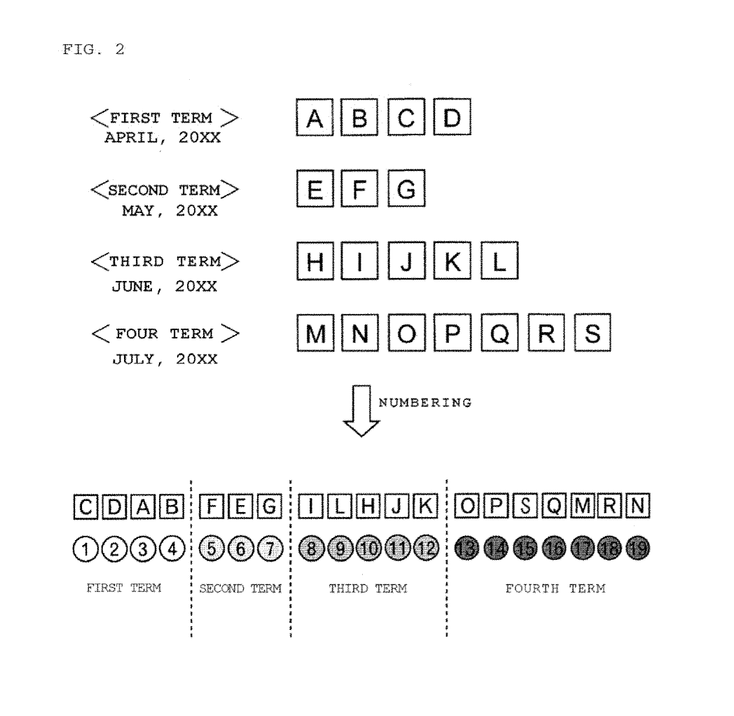

For example, a case as illustrated in FIG. 2 is considered. In FIG. 2, an upper-case alphabetic character represents a purchaser who fulfills the entry requirement and the purchasers are assumed to have fulfilled the entry requirement in order of A, B, C, . . . .

Four persons A to D are registered in the first term (the first entry term), and serial numbers 1 to 4 are assigned to A to D.

In the second term that is the next entry term, it is assumed that three persons E to G are registered. Serial numbers 5 to 7, which are larger than serial numbers of A to D registered in the first term, are assigned as serial numbers to E to G.

Similarly, 8 to 12 are assigned as serial numbers to H to L registered in the third term and 13 to 19 are assigned as serial numbers to M to S registered in the fourth term.

Note that within a specific entry term, serial numbers are not necessarily numbered in order of fulfilling the entry requirement (however, such case does not fall outside the scope of the present invention).

For example, in the example of FIG. 2, E to G are assigned serial numbers 5 to 7 as serial numbers, but E is not necessarily assigned “5”, F is not assigned “6”, and G is not assigned “7”.

In the numbering registration step, it is preferable that the numbering registration means randomly determines serial numbers of a plurality of purchasers belonging to a specific entry term (for example, as illustrated in FIG. 2).

As described above, according to the present invention, there is a tendency that a person who became a member later is assigned a larger serial number (that is, the person is positioned at a higher position of the hierarchy and can receive a large bonus). Therefore, if the serial number is numbered in order of fulfilling the entry requirement even in the entry term, the purchaser expects a high bonus, and tries to make an entry at the end of the entry term (for example at the end of the month) such that a large serial number is assigned (because the purchaser wants to be assigned a larger serial number). As a result, entries concentrate at the end of the entry term, and problems of clerical processing such as hindering the operation of a system operator are likely to occur.

It is possible to avoid such problems of clerical processing by configuring the numbering registration means to randomly determine the serial numbers of a plurality of purchasers belonging to the entry term.

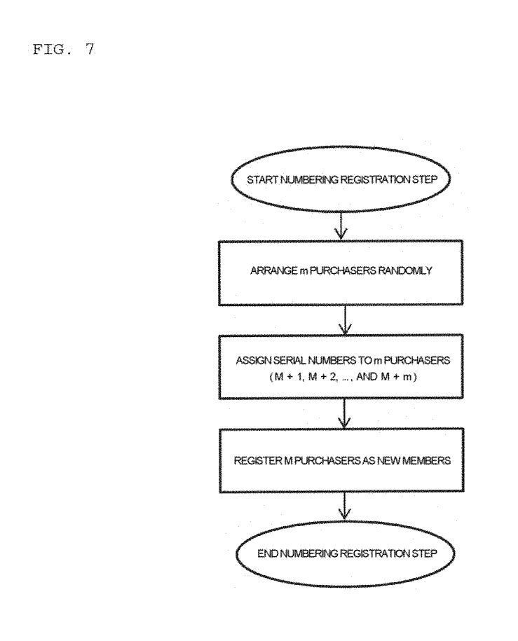

FIG. 7 illustrates a flow of processing in the numbering registration step (in a case where the serial numbers of a plurality of purchasers belonging to a specific entry term are randomly determined).

When the entry term expires and the entry term determination step is performed, the number of purchasers belonging to the entry term is determined (assumed to be m).

In the numbering registration step, the numbering registration means of the computer arranges the m persons in random order. Then, in a case where the largest number among the serial numbers of purchasers belonging to the immediately preceding entry term is set to M, serial numbers of M+1, M+2, . . . , and M+m are assigned to the above m persons. When the serial numbers are assigned, the above m persons are registered as new members belonging to the hierarchical structure.

FIG. 10 illustrates an example of a screen in which members belonging to the hierarchical structure are arranged in order of serial numbers.

In FIG. 10, as a member listed in an upper line (with a smaller number listed in “arrangement order”), the member has a larger serial number. However, the serial number itself is not described in FIG. 10 (note that the number in “arrangement order” is not the serial number).

In addition, in FIG. 10, a middle part is omitted.

The “serial number” in the present invention is a concept introduced to determine the bonus amount to each member in the numbering registration step, the arrangement step, the bonus amount calculation step.

As the number of members increases, it is not practical to perform the numbering registration step, the arrangement step, the bonus amount calculation step by human hand, and all these steps are done by the computer.

Therefore, a human such as an operator does not grasp the serial number of each member at all. For this reason, the serial number itself is not described in the screen of FIG. 10, and when the present invention is implemented, a means for displaying the serial number does not need to be provided.

From FIG. 10, it can be seen that members who have joined in the same month (fulfill the entry requirement) are randomly assigned a serial number (are not arranged in the order of date of admission).

### <Arrangement Step>

The arrangement step is a step in which every time the bonus granting time arrives, an arrangement means arranges a member who maintains a bonus granting requirement such that the larger the serial number is, the higher position the member is arranged at and the hierarchy is filled sequentially from the top.

The arrangement step is performed to determine the arrangement of members in the hierarchy in order to determine the bonus amount to be granted to the registered member.

An arrangement method in which a member who has newly enters the hierarchical structure is positioned at a higher position is an arrangement method greatly different from the conventional method and the effect of the present invention is exhibited by this arrangement method.

The arrangement step is performed every time the bonus granting time arrives. Therefore, the arrangement step may be performed at any time until the bonus granting time arrives, for example, immediately before the bonus granting time arrives or immediately after the entry term expires and then the numbering registration step is implemented.

After the arrangement step is performed, the bonus amount calculation step and the bonus granting step are subsequently performed, and a bonus is granted to the member who has the right to receive the bonus.

Although the bonus granting time arrives at regular intervals, arrival frequency may be the same as or different from the length of the entry term.

In a case where one month from the beginning of the month to the end of the month is set as an entry term, an example of the former case is that the bonus is granted on a fixed day (for example, 20th) of the following month.

In a case where one month from the beginning of the month to the end of the month is set as an entry term, an example of the latter case is that the bonus is not granted monthly but is granted every two months (for example, the bonus is granted on the 20th day of odd months).

In the latter case, in a case an even month is later than an odd month, a person who made an entry in the even month that is later than the odd month can obtain a larger serial number. Therefore, entries are expected to concentrate in the even month. For this reason, the former case (that is, the frequency at the bonus granting time arrives is the same as the entry term length) is preferable, and in the present description, an example of the former case will be described.

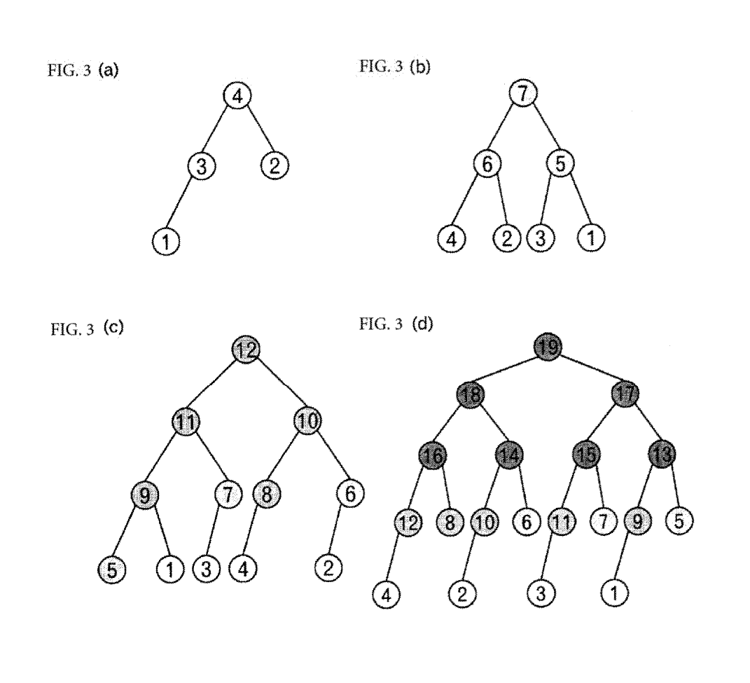

FIG. 3 illustrates an example of how to arrange in the arrangement step, regarding a case where numbering is performed as illustrated in FIG. 2 in the numbering registration step.

After the expiration of the first term (April 20xx), the number of members in the hierarchical structure is four.

When the members are arranged and the hierarchy is filled sequentially from the top such that “4” that is a large serial number is on the highest position, for example, the arrangement after the expiration of the first term as illustrated in FIG. 3(a) is obtained.

According to this arrangement, the bonus amount to be granted to each member when the bonus granting time arrives after the expiration of the first term is determined.

After the expiration of the second term (May 20xx), the number of members in the hierarchical structure is seven (after the expiration of the second term, there are three new members, and four existing members).

When the members are arranged and the hierarchy is filled sequentially from the top such that so that “7” that is a large serial number becomes the highest position, for example, an arrangement after the expiration of the second term as illustrated in FIG. 3(b) is obtained.

The new members “7”, “6”, and “5” are arranged higher than the existing members “4”, “3”, “2”, and “1”.

According to this arrangement, the bonus amount to be granted to each member when the bonus granting time arrives after the expiration of the second term is determined.

Similarly, the arrangement after the expiration of the third term (June 20xx) and the arrangement after the expiration of the fourth term (July 20xx) as illustrated in FIGS. 3(c) and (d) are obtained. The bonus amount to be granted to each member when the bonus granting time arrives after the expiration of each entry term is determined.

In the example illustrated in FIG. 3, for example, “4” has three subordinate persons after the expiration of the first term, but “4” has no subordinate persons after the expiration of the second term.

Similarly, “7” has six subordinate persons after the expiration of the second term, but has one subordinate person after the expiration of the third term and has no subordinate person after the expiration of the fourth term.

According to the present invention, the purchaser can receive the bonus corresponding to the number of subordinate persons every time the bonus granting time arrives after the expiration of the entry term. However, it can be seen from the example illustrated in FIG. 3 that the purchaser tends to be able to receive a large bonus immediately after he or she becomes a new member, but as the time progresses, the bonus amount that he or she can receive decreases.

In the arrangement step, a method of arranging members in a specific hierarchy is preferably a method in which members are arranged alternately on the left and right sides with members with large serial numbers on the left side.

In the example illustrated in FIG. 3, the members are arranged according to such rule.

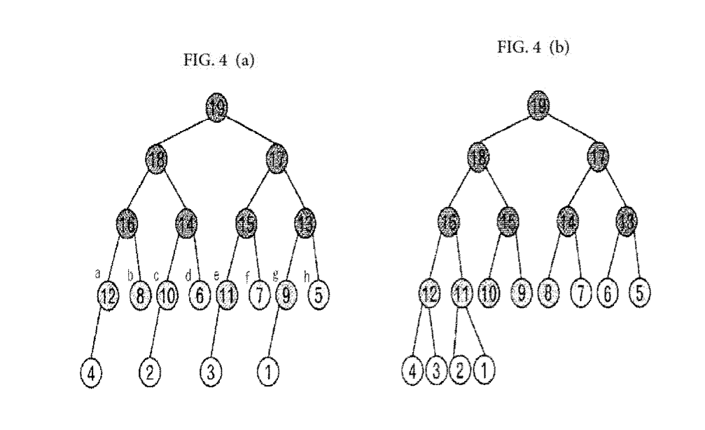

When the arrangement is performed, for example, as illustrated in FIG. 4(b) to be described later, members who fulfill the entry requirement in the same entry term may become unequal in some cases. Therefore, it is preferable to use the rule to improve such cases. The rule in the arrangement step will be described below.

“Members are arranged alternately on the left and right sides with members with large serial numbers on the left side” means filling positions positioned on the left side first in a target hierarchy (in a case where there is a plurality of positions on the left side, going up to a hierarchy upper than the target hierarchy and then filling positions on the left side first).

Description will be given while taking the fourth hierarchy from the top in FIG. 4(a) as an example (see a lower-case alphabetic character illustrated in the upper left of a circle with a number written therein in FIG. 4 (a)).

In the fourth hierarchy, the positions positioned on the left side are a, c, e, and g, and these positions are filled before b, d, f, and h positioned on the right side (that is, members with large serial numbers are arranged). Among a, c, e, and g, a and e positioned on the left side also in a hierarchy (third hierarchy) that is higher by one level are filled before c and g. When looking at a further upper hierarchy (the second hierarchy), since a is on the left side and e is on the right side, a is filled before e.

By thinking in the same way, the order of the arrangement in the fourth hierarchy is a, e, c, g, b, f, d, and h. In this order, when “12” to “5” are arranged in descending order of the serial numbers, an arrangement as illustrated in FIG. 4(a) is obtained.

In addition, in a case where a target and specific hierarchy is the n-th hierarchy from the top, “members are arranged alternately on the left and right sides with members with large serial numbers on the left side” means arranging members with large serial numbers in descending order from a position with a large value of P expressed by the following formula.

$$P = {\sum }_{i = 2}^{n} {2}^{i} {a}_{i} \qquad [ Formula 1 ]$$

(aᵢ=1 in a case where the i-th hierarchy from the top is on the left side, and aᵢ=0 in a case where the i-th hierarchy from the top is on the right side.)

The members are arranged alternately on the left and right sides with the members with large serial numbers on the left side in the specific hierarchy. As a result, it is possible to make positions between members who fulfilled the entry requirements in the same entry term (members who fulfilled the entry requirements at almost the same time) close to equal.

For example, an arrangement after the expiration of the fourth term in the example illustrated in FIG. 2 is considered. FIG. 4(a) illustrates a case where members are arranged alternately on the left and right with members with large serial numbers on the left side (that is, the same arrangement as that in FIG. 3(d)). FIG. 4(b) illustrates a case where members with large serial numbers are arranged sequentially from the left side.

Table 1 illustrates the number of subordinate persons after the expiration of the fourth term for each of new members in the fourth term (members with serial numbers 13 to 19) for each case of (a) and (b) of FIG. 4.

TABLE 1

| | (a) | (b) |
|---|---|---|
| “13” | 3 | 2 |
| “14” | 3 | 2 |
| “15” | 3 | 2 |
| “16” | 3 | 6 |
| “17” | 8 | 6 |
| “18” | 8 | 10 |
| “19” | 18 | 18 |

Even among the new members in the same fourth term, there is a large difference in the number of subordinate persons, and this difference results in a large difference in a receivable bonus amount after the expiration of the fourth term.

Thus, it is unavoidable in terms of operation that a small difference in serial numbers numbered (it is preferable that serial numbers of a plurality of purchasers in an entry term are randomly determined as described above) among members who fulfilled the entry requirement in the same entry term (members who fulfilled the entry requirement at almost the same time) results in a difference in a receivable bonus amount (luck is involved). However, as illustrated in FIG. 4(a), members are arranged alternately on the left and right side with members with large serial numbers on the left side. As a result, it is possible to make positions of members who fulfill the entry requirement in the same entry term close to equal, as compared with a case where members with large serial numbers are arranged sequentially from the left side as illustrated in FIG. 4(b).

In the arrangement step, the member to be arranged such that the larger the serial number is, the higher position the target member is arranged at is the member who maintains the bonus granting requirement.

“Maintaining the bonus granting requirement” means that maintaining the requirement to keep participating in the hierarchical structure (requirement for receiving the bonus).

Specifically, for example, a case where after the purchaser participates in the hierarchical structure as a member, the purchaser purchases a certain number of products or a product of a certain amount of money in every certain period of time can be referred to as “maintaining the bonus granting requirement”.

For example, in the first example to be described later, the entry term is set as one month from the beginning of the month to the end of the month, and a monthly bonus is granted to members in the hierarchical structure, but the “bonus granting requirement” is “purchasing at least one product monthly”. For this reason, a member who does not purchase at least one product in a month leaves the hierarchical structure and loses the right to receive the bonus.

Of course, it is possible to make the “bonus granting requirement” unconditional (absolutely prevent the member who participates in the hierarchical structure once from leaving the hierarchical structure). However, since the present invention is targeted mainly to products consumed regularly such as cosmetics and health foods and beverages, it is preferable that some requirement is imposed as the “bonus granting requirement” from a viewpoint of securing purchasers.

In a case where some requirement is imposed as the “bonus granting requirement”, a measure may be provided to prevent a member who has an intention to maintain the “bonus granting requirement” from leaving the hierarchical structure unintentionally due to a reason such as that the member has forgotten to purchase (for example, a certain number of products or a product of a certain amount of money is regularly shipped to a member who desires to do so do even if there is no order from the member).

Examples illustrated in FIGS. 2 to 4 are examples for description and the number of members is small. However, in a case where the present invention is actually implemented, the number of members is remarkably large, and furthermore, as the entry term progresses, the number of members increases explosively. The arrangement step can be performed by human hand in a case where the number of member is at most several hundreds (the number of hierarchies is about eight hierarchies). The arrangement step needs to be performed by the arrangement means of the computer.

### <Bonus Amount Calculation Step>

The bonus amount calculation step is a step in which the bonus amount calculation means calculates, regarding each arranged member, a value obtained by multiplying the number of subordinate persons (limited to subordinate persons within a certain number of hierarchies (N)) viewed from the member by the unit bonus amount.

“Subordinate persons viewed from the member” means all subordinate persons viewed from any member in the hierarchical structure.

For example, the subordinate persons viewed from “11” in FIG. 3(c) (arrangement after the expiration of the third term) is five persons of “9”, “7”, “5”, “3”, and “1”.

Table 2 summarizes the number of subordinate persons viewed from each member after each entry term, regarding the example illustrated in FIG. 3.

TABLE 2

| | | After | After | After | After |
|---|---|---|---|---|---|
| Entry | | first | second | third | fourth |
| term | Member | term | term | term | term |
| First | “1” | 0 | 0 | 0 | 0 |
| term | “2” | 0 | 0 | 0 | 0 |
| | “3” | 1 | 0 | 0 | 0 |
| | “4” | 3 | 0 | 0 | 0 |
| Second | “5” | | 2 | 0 | 0 |
| term | “6” | | 2 | 1 | 0 |
| | “7” | | 6 | 1 | 0 |
| Third | “8” | | | 1 | 0 |
| term | “9” | | | 2 | 1 |
| | “10” | | | 4 | 1 |
| | “11” | | | 5 | 1 |
| | “12” | | | 11 | 1 |
| Fourth | “13” | | | | 3 |
| term | “14” | | | | 3 |
| | “15” | | | | 3 |
| | “16” | | | | 3 |
| | “17” | | | | 8 |
| | “18” | | | | 8 |
| | “19” | | | | 18 |

In the bonus amount calculation step, the bonus amount calculation means calculates the number of subordinate persons (limited to subordinate persons within a certain number of hierarchies (N)) viewed from each member according to the arrangement determined in the arrangement step, and calculates a value obtained by multiplying the number of subordinate persons by a predetermined unit bonus amount (X), and set this resultant amount as a bonus amount to be granted to each member.

From Table 2, it can be seen that immediately after the purchaser becomes a new member (participates in the hierarchical structure), the number of subordinate persons is large (the granted bonus amount is large), but as the time progresses, the number of subordinate persons becomes smaller.

This is because as new members come into the hierarchical structure, the existing members are arranged in the lower hierarchy, and as the hierarchy goes down to lower hierarchies, the number of members forming the hierarchy increases in an exponential fashion.

For example, in a case where the number of members is 1023 (2¹⁰−1) (in a case where the 10th hierarchy from the top is filled), “1023” is positioned at the top of the hierarchy and has 1022 subordinate persons. However, in a case where the number of members reaches 2047 (2¹¹−1) that is about double 1022 (in a case where the 11th hierarchy from the top is filled), “1023” is driven to the lowest hierarchy (the 11th hierarchy from the top) and has no subordinate person.

Such method of determining a bonus amount is suitable for the purpose of the present invention that is to promote the participation of new product purchasers and have the purchased product actually be used and as a result, secure only purchasers who are really satisfied with the quality of the product or the like as continuation purchasers (repeaters).

In addition, as the number of members increases, the number of hierarchies also increases, and the number of subordinate persons viewed from a superordinate member increases. However, the number of subordinate persons who serve as the basis for calculating the bonus amount is infinite, it is obvious that the system will fail.

In the bonus amount calculation step in the method of the present invention, such situation is prevented by limiting the subordinate persons who serve as the basis for calculating the bonus amount to subordinate persons within a certain number of hierarchies (N).

A certain number of hierarchies (N) is preferably 7≤N≤11, more preferably 8≤N≤10, and particularly preferable N=9.

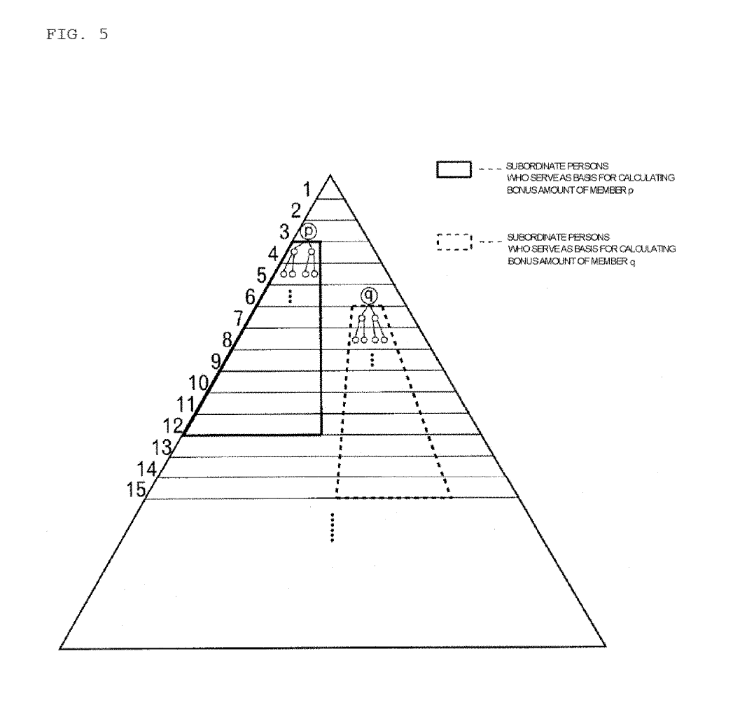

For example, an example in the case of N=9 is illustrated in FIG. 5 For a member p positioned in the third hierarchy from the top, the subordinate persons who serve as the basis for calculating the bonus amount are subordinate person positioned in up to the 12th hierarchy from the top. For a member q positioned at the sixth hierarchy from the top, the subordinate persons who serve as the basis for calculating the bonus amount are subordinates positioned in up to the 15th hierarchy from the top.

In the case of N=9, the maximum number of subordinate persons who serve as the basis for calculating the bonus amount is 2+2²+2³+ . . . +2⁹ (=1022), an amount obtained by multiplying 1022 by the unit bonus amount (X) is the maximum amount of money that the member can receive at one time.

The bonus amount calculation step is performed by the bonus amount calculation means of the computer after the arrangement step is performed by the arrangement means. However, the bonus amount calculation step is preferably performed immediately after the arrangement step is completed.

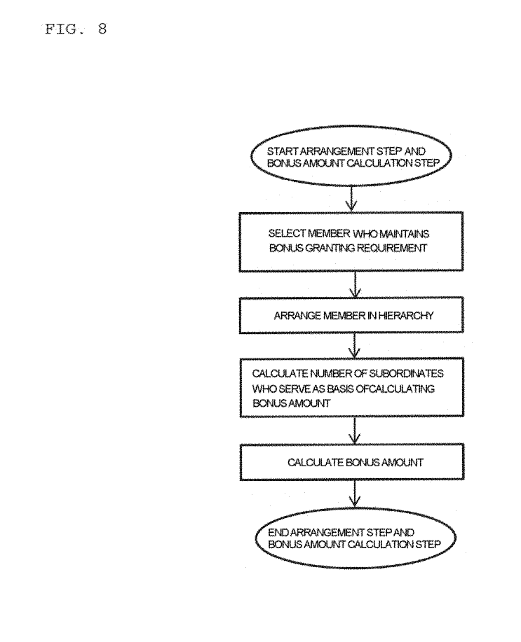

FIG. 8 illustrates a flow of processing in the arrangement step and the bonus amount calculation step (in a case where the bonus amount calculation step is performed immediately after the arrangement step is completed).

First, the computer determines whether each registered member who maintains the bonus granting requirement and selects only the member who maintains the bonus granting requirement as a target to be arranged in the hierarchy.

For example, in a case where “purchasing at least one product monthly” is set as the bonus granting requirement, the computer excludes the member who does not purchase any product from the target to be arranged in the hierarchy and selects another member in the hierarchy as the target to be arranged.

When the selection of the member to be arranged in the hierarchy is completed, the arranging means arranges the member such that the higher the serial number, the higher position the member is positioned at, and fills the hierarchy sequentially from the top, and fixes the arrangement of each member.

After the arrangement is fixed, the bonus amount calculating means calculates the number of subordinate persons (limited to subordinate persons within a certain number of hierarchies (N)) viewed from each arranged member.

The bonus amount calculating means calculates and outputs a value obtained by multiplying the calculated number of subordinate persons by the unit bonus amount (X) as the bonus amount to be granted to each member.

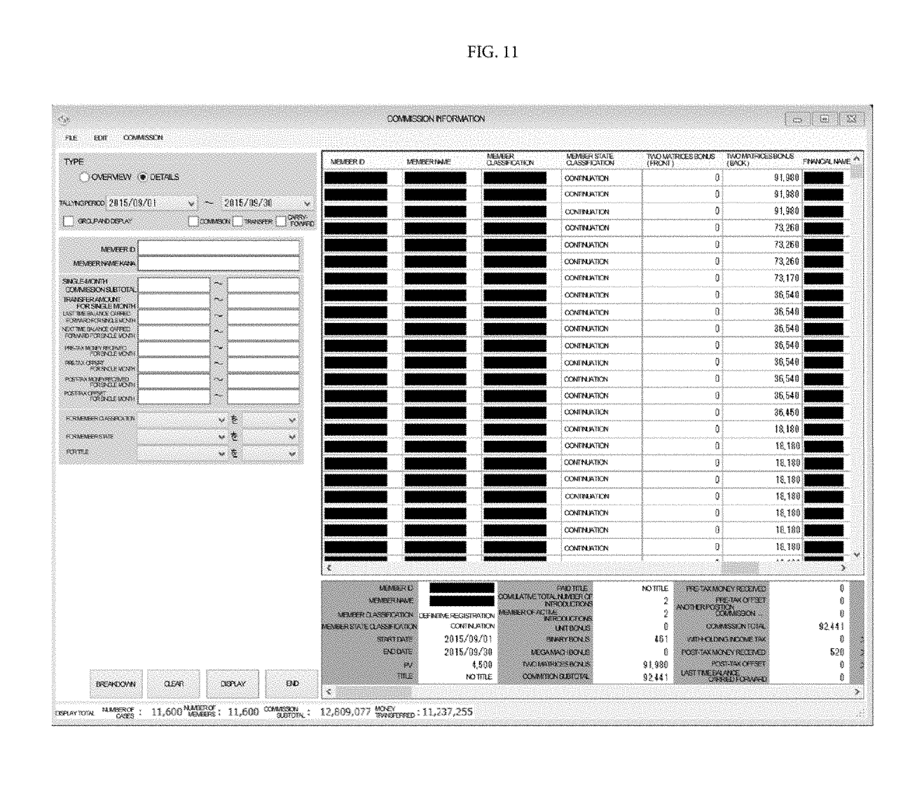

FIG. 11 illustrates an example of a screen illustrating the bonus amount to be granted to each member. In FIG. 11, the numerical value illustrated in the “two matrices bonus (back)” column is the bonus amount (unit: yen) to be granted to each member.

In FIG. 11, a member with a large bonus amount tends to be assigned a large serial number, but members having the same bonus amount are not arranged in order of serial numbers from the top.

As described above, since all of the numbering registration step, the arrangement step, and the bonus amount calculation step are performed by the computer, the human such as the operator does not need to grasp the serial number. The human such as the operator only has to know the bonus amount to be granted to each member at the bonus granting time.

In addition, since the arrangement step and the bonus amount calculation step are performed by the hand of the computer, the human such as the operator does not grasp the hierarchical structure and the hierarchical structure does not need to be made visually displayable.

### <Bonus Granting Step>

The bonus granting step is a step of granting the bonus to each member.

Since the bonus amount to be granted to each member in the hierarchy is determined by the bonus amount calculation step, the bonus of that amount is granted to each member.

The bonus may be granted with money or may be granted in the form of a prize, points, or the like.

### <Other Steps>

As described above, the product sales promotion method of the present invention includes at least the entry term determination step, the numbering registration step, the arrangement step, the bonus amount calculation step, and the bonus granting step. However, the method may further include other steps.

As an example of other steps, a step for granting a bonus separately from the bonus to be granted to the member by the above-mentioned bonus granting step (hereinafter referred to as “regular bonus”) is conceivable.

A member who did not maintain the bonus granting requirement (for example, the member who did not purchase at least one product in a month in a case where “purchasing at least one product monthly” is set as the bonus granting requirement”), the member leaves the hierarchical structure for receiving the regular bonus.

However, such member who left the hierarchical structure may be positioned at the lowest position in the hierarchical structure, and a step may be provided for granting a bonus separately from the regular bonus, and the bonus may be granted to the member who left the hierarchical structure.

In addition, as described above, in order to fulfill the entry requirement or to maintain the bonus granting requirement, it is typically necessary to purchase a certain number of products or a product of a certain amount of money. However, it is thought that a member who purchases more products than the minimum number of products or a product for the minimum amount of money necessary for fulfilling the entry requirements or maintaining the bonus granting requirement (hereinafter referred to as “extra product”) appears. In such case, the extra product may be assumed to be a purchaser and positioned at the lowest position in the hierarchical structure, and a step may be provided to grant an additional bonus according to the number of extra products to the member in the hierarchical structure.

The method of the present invention is suitable for the purpose of having many consumers experience the product first, have purchasers who are truly satisfied with the quality of the product remain as continuation purchasers (repeaters). Therefore, consumable products such as cosmetics, health foods and beverages are preferable as products to which the present invention is applied.

The method of the present invention is fundamentally different from the conventional methods in that the method of the present invention is set such that a newly entered consumer can receive a large bonus.

By using the method of the present invention, a consumer who knows for the first time a product sold by a seller is strongly motivated to purchase the product, and the seller can easily acquire a new product purchaser. Meanwhile, it is clear that with the method of the present invention, the bonus amount that the member can receive decreases as the time progresses.

Therefore, in a case where the method of the present invention is implemented, a person who aims to obtain the bonus tends not to become a member from the beginning or to immediately leave. That is, a person who likes a product after actually using the product remain as a member.

The method of the present invention can be said to be a method that suits the wish of the seller who wants many consumers to know good quality products and wants to provide the products to the consumers who truly desire the product.

### EXAMPLES

Hereinafter, the present invention will be described more specifically with reference to an example and a comparative example, but the present invention is not limited to the examples and the comparative example unless the gist thereof is exceeded.

### Example 1

The method of the present invention was applied and cosmetics, drinking water, health sheets, and the like were sold.

### [Entry Requirement]

A setting was made such that in a case where a specific purchaser fulfills any of the following, the case was referred to as “fulfilling the entry requirement”.

(a) The purchaser himself or herself purchased three products.

(b) The purchaser himself or herself purchased two products and introduced the products to one other person.

(c) The purchaser himself or herself purchased one product and introduced the product to two other persons.

### [Entry Term and Bonus Granting Time]

One month from the beginning of the month to the end of the month and was set as an entry term and a bonus was set to be granted to a member on around the 20th of the following month.

### [Numbering Method]

Serial numbers of a plurality of purchasers belonging to a specific entry term were set to be determined at random.

### [Arrangement Method]

As illustrated in FIG. 1(a), a pyramid-type hierarchical structure composed of members who fulfills an entry requirement was set to be two subordinate persons for one superior person.

A method of arranging members within the specific hierarchy was set such that members are arranged alternately on the left and right sides with members with large serial numbers on the left side.

### [Bonus Granting Requirement]

“Purchasing at least one product monthly” was set as a bonus granting requirement. That is, a member who does not purchase at least one product in a month was set to leave the hierarchical structure and loses the right to receive the bonus.

### [Bonus Amount Calculation Method]

A subordinate person serve as the basis for calculating the bonus amount was supposed to be a subordinate person within nine levels (that is, N=9).

In addition, the unit bonus amount (X) was set to 90 yen obtained by multiplying 4500 yen, which is a substantial average selling price of products excluding a shipping cost by 2%.

As a result of this setting, the maximum number of subordinate persons who serve as the basis for calculating the bonus amount is 2+2²+2³+ . . . +2⁹ (=1022) persons, and the maximum amount of money that the member can receive at one time was 1022×90 (=91980) yen.

Selling was started from November 2014 under the above conditions.

FIG. 12(a) illustrates screens excerpted from a part of the arrangement order of the members in the bonus granting time after expiration in October 2015, and FIG. 12(b) illustrates a part of the arrangement order of the members in the bonus granting time after expiration in November 2015.

Since as a person listed in an upper line, the person has a larger serial number and is positioned at a higher position of the hierarchy, the person can receive a large bonus.

In FIG. 12(a), members a, b, c, . . . are members who joined in October 2015 (fulfilled the entry requirement). Since the members a, b, c, . . . were positioned at relatively higher positions in the hierarchical structure at a point in time of the expiration in October 2015, the member a, b, c, . . . could receive a large bonus, as illustrated in Table 3.

Meanwhile, in the bonus granting time after expiration in November 2015, in order that 238 members who joined (fulfilled the entry requirement) in November 2015 newly participates, with larger serial numbers than that of the member a, in the hierarchical structure, the members a, b, c, . . . were positioned below the 238 persons, and the bonus amount that the members a, b, c, . . . can receive drastically decreased as illustrated in Table 3.

TABLE 3

| | After expiration on | | After expiration on | |
|---|---|---|---|---|
| | October 2015 | | November 2015 | |
| | | Number of | | Number of |
| | Bonus amount | subordinate | Bonus amount | subordinate |
| Member | (yen) | persons | (yen) | persons |
| a | 91980 | 1022 | 2070 | 23 |
| b | 91980 | 1022 | 2070 | 23 |
| c | 91980 | 1022 | 2070 | 23 |
| d | 73260 | 814 | 2070 | 23 |
| e | 73260 | 814 | 2070 | 23 |
| f | 73260 | 814 | 2070 | 23 |
| g | 73170 | 813 | 2070 | 23 |
| h | 36540 | 406 | 2070 | 23 |
| i | 36540 | 406 | 2070 | 23 |
| j | 36540 | 406 | — | — |
| k | 36540 | 406 | 2070 | 23 |
| l | 36540 | 406 | 2070 | 23 |
| m | 36540 | 406 | 990 | 11 |
| n | 36540 | 406 | — | — |
| o | 18180 | 202 | — | — |
| p | 18180 | 202 | 990 | 11 |
| q | 18180 | 202 | 990 | 11 |
| r | 18180 | 202 | — | — |
| s | 18180 | 202 | 990 | 11 |
| t | 18180 | 202 | 990 | 11 |
| u | 18180 | 202 | 990 | 11 |
| v | 18180 | 202 | 990 | 11 |
| w | 18180 | 202 | 990 | 11 |
| x | 18180 | 202 | 990 | 11 |

In addition, members j, n, o, and r are described in FIG. 12(a), but are not described in FIG. 12(b). These members are members who left the hierarchical structure because the members did not purchase at least one product in November 2015.

### INDUSTRIAL APPLICABILITY

In the product sales promotion method of the present invention, the seller who wishes many people to know good points of products easily acquire new product purchasers and only purchasers who are truly satisfied with the quality of the products or the like remains as continuation purchasers (repeaters). Therefore, the method is to be widely used as a method for promoting sales of consumable products such as cosmetics, health foods and beverages.

1-6. (canceled)

7. A product sales promotion method in which a serial number is assigned to a purchaser who fulfills a specific entry requirement and then the purchaser is registered as a member in a pyramid-type hierarchical structure composed of purchasers, and a bonus of an amount according to the number of subordinate persons viewed from each member is periodically given to the member, and as a result, willingness to purchase a product is increased, the product sales promotion method comprising at least:
an entry term determination step in which a storage means is caused to store a point in time when the purchaser who fulfills the entry requirement fulfilled the entry requirement and an entry term to which each purchaser belongs is determined;
a numbering registration step in which every time the entry term expires, a numbering registration means assigns a serial number of the purchaser belonging to the entry term such that the serial number is larger than a serial number assigned to an existing member belonging to an immediately preceding entry term and registers the purchaser belonging to the entry term as a new member;
an arrangement step in which every time bonus granting time arrives, an arrangement means arranges a member maintaining a bonus granting requirement such that the larger the serial number is, the higher position the member is arranged at, and the hierarchy is filled sequentially from the top;
a bonus amount calculation step in which a bonus amount calculating means calculates, regarding each arranged member, a value obtained by multiplying the number of subordinate persons (limited to subordinate persons within a certain number of hierarchies (N)) viewed from the member by a unit bonus amount; and
a bonus granting step in which a bonus is granted to each member.

8. The product sales promotion method according to claim 7, wherein in the numbering registration step, the numbering registration means randomly determines serial numbers of a plurality of purchasers belonging to a specific entry term.

9. The product sales promotion method according to claim 7, wherein in the arrangement step, a method of arranging members in a specific hierarchy is a method in which members are arranged alternately on left and right side with members with large serial numbers on the left side.

10. The product sales promotion method according to claim 8, wherein in the arrangement step, a method of arranging members in a specific hierarchy is a method in which members are arranged alternately on left and right side with members with large serial numbers on the left side.

11. The product sales promotion method according to claim 7, wherein 7≤N≤11.

12. The product sales promotion method according to claim 11, wherein N=9.

13. The product sales promotion method according claim to 7, wherein the entry term is one month from the beginning of the month to the end of the month.

14. The product sales promotion method according to claim 8, wherein the entry term is one month from the beginning of the month to the end of the month.

15. The product sales promotion method according to claim 9, wherein the entry term is one month from the beginning of the month to the end of the month.

16. The product sales promotion method according to claim 10, wherein the entry term is one month from the beginning of the month to the end of the month.
